(19) United States
(12) Patent Application Publication
(10) Pub. No.: US 2010/0228583 A1
(43) Pub. Date: Sep. 9, 2010

(54) ENERGY MODELLING

(75) Inventor: Zoe Francesca BANFIELD, Farnborough (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc, London (GB)

(21) Appl. No.: 12/717,726

(22) Filed: Mar. 4, 2010

(30) Foreign Application Priority Data
Mar. 6, 2009 (EP) 09275013.2
Mar. 6, 2009 (GB) 0903887.8

(51) Int. Cl. G06Q 10/00; G06F 3/048

(52) U.S. Cl. 705/7; 715/771

(57) ABSTRACT

There is provided a system for use in physically reconfiguring a supply chain. The system includes a memory for storing energy-related components within a supply chain, and a processor for evaluation of energy consumption within the supply chain in accordance with a current scenario and at least one alternative scenario in which at least one energy-related component or physical parameter within the supply chain is changed. A user interface displays the energy consumption of the current scenario and the at least one alternative scenario.

### FIELD OF THE INVENTION

The present invention relates to a system for use in physically reconfiguring a supply chain in a military and/or commercial setting, and more particularly, to a system for use in physically reconfiguring a supply chain by evaluating fully burdened measures of the supply chain under at least one alternative scenario.

### BACKGROUND OF THE INVENTION

Computer architecture is the conceptual design and fundamental operational structure of a computer system, which transforms information into a format, which can then be used to implement a physical transformation or change within a system and/or process. For example, computer implemented business modelling describes a broad range of informal and formal models that are used by enterprises and/or businesses to represent various aspects of business, such as operational processes, organizational structures, and financial forecasts and which produce physical changes or transformations of the various aspects of the business.

### SUMMARY OF THE INVENTION

In one aspect, this invention provides a system for use in physically reconfiguring a supply chain, comprising: a memory for storing energy-related components within a supply chain; a processor for evaluation of energy consumption within the supply chain in accordance with a current scenario and at least one alternative scenario in which at least one energy-related component or physical parameter within the supply chain is changed; and a user interface for displaying the energy consumption of the current scenario and the at least one alternative scenario. In another aspect, this invention provides a system for use in physically reconfiguring a supply chain, comprising: a memory for storing energy-related components within a supply chain; a processor for evaluation of energy consumption within the supply chain in accordance with a first state and at least one second state in which at least one energy-related component or physical parameter within the supply chain is changed; and a user interface for displaying the energy consumption of the first state and the at least one second state.

In another aspect, this invention provides a system for use in physical reconfiguring energy consumption of a supply chain, comprising: a memory for storing physical parameters for energy consumption of a supply chain; a processor for evaluation of energy consumption of the supply chain, and wherein upon a change in a physical parameter of the supply chain, the processor calculates a new energy consumption of the supply chain; and a user interface for displaying an original energy consumption and the new energy consumption of the supply chain.

In another aspect, this invention provides a method of monitoring energy consumption, comprising: calculating energy consumption of a supply chain; recalculating the energy consumption of the supply chain by changing at least one energy-related component or physical parameter within the supply chain; displaying the energy consumption of the supply chain as a result of the changing the at least one energy-related component or physical parameter within the supply chain; and reconfiguring the supply chain in accordance with the change in the at least one energy-related component or physical parameter within the supply chain.

The invention extends to a computer readable medium containing a computer program for displaying energy consumption of a supply chain. The computer program comprises executable instructions for: calculating energy consumption of a supply chain; recalculating the energy consumption of the supply chain by changing at least one energy-related component or physical parameter within the supply chain; displaying the energy consumption of the supply chain as a result of the changing the at least one energy-related component or physical parameter within the supply chain; and reconfiguring the supply chain in accordance with the changing the at least one energy-related component or physical parameter within the supply chain.

The above and further features of the present invention are set forth in the appended claims and, together with advantages thereof, will become more clear from consideration of the following detailed description of exemplary embodiments and Examples of the invention given with reference to the accompanying drawings.

### BRIEF DESCRIPTION OF THE DRAWINGS

FIG. 1 illustrates a system for use in physically changing a supply chain in accordance with an exemplary embodiment;

FIG. 2 illustrates a system for use in physically changing a supply chain in accordance with another exemplary embodiment;

FIG. 3 illustrates a system for use in physically changing a supply chain in accordance with another embodiment;

FIG. 4 illustrates a fully burdened cost of energy resupply routes in accordance with an exemplary embodiment;

FIG. 5 illustrates a high level process diagram using a fully burdened cost of energy database model and associated dynamic models;

FIG. 6 illustrates a fully burdened cost of energy diagram in accordance with an exemplary embodiment;

FIG. 7 illustrates a high level view of a fully burdened cost of a supply chain in accordance with another exemplary embodiment; and

FIG. 8 is a flow chart that illustrates a series of steps for monitoring energy consumption in accordance with an exemplary embodiment.

### DETAILED DESCRIPTION OF EXEMPLARY EMBODIMENTS AND EXAMPLES

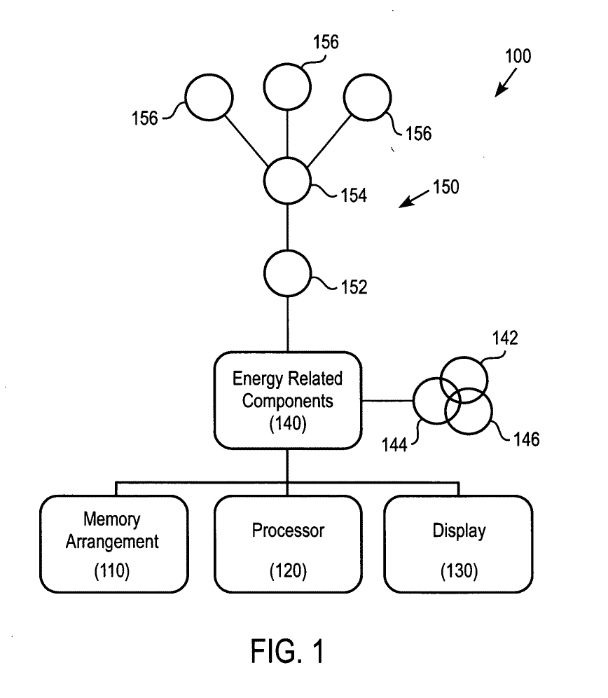

Exemplary embodiments disclosed herein are directed to a computer system and/or software system for use in physically changing a supply chain in a military and/or commercial setting. In accordance with an exemplary embodiment, it would be desirable to graphically display energy use across all branches of a military service including supply lines, to reduce costs, meet carbon dioxide and emission targets, improve security of supply in-theatre and at home, and maintain an effective use of energy and energy-related supplies and/or functions. In accordance with an exemplary embodiment, the system links equipment, infrastructure and personnel involved in the energy supply chain to instances of energy delivery to a point of use. FIG. 1 illustrates an exemplary system 100 for use in physically changing a supply chain in accordance with an exemplary embodiment. The system 100 includes a memory or memory arrangement 110, a processor 120, and a user interface (or display) 130.

The memory or memory arrangement 110 is configured to store energy-related components 140 within a supply chain 150. In accordance with an exemplary embodiment, the energy-related components 140 within the supply chain 150 are related to a military service or branch, within a country of origin and/or a foreign country. The supply chain 150 can include a home base 142, an optional intermediate camp (or first level base camp) 144, and one or more outlining bases and/or destinations 146. In accordance with an exemplary embodiment, the energy-related components 140 are generated across all branches of services having energy uses including training (i.e., non-operational uses) 142, deployment and operations 144, and/or estate energy 146 (i.e., the running of building and facilities).

The processor 120 is configured to evaluate energy consumption within the supply chain 150 in accordance with a current scenario (i.e., original energy consumption) and at least one alternative scenario (i.e., new energy consumption) in which at least one energy-related component 140 within the supply chain 150 is changed.

The user interface (or display) 130 is configured to display the energy consumption of the current scenario and at least one alternative scenario. The user interface 130 can be a display, a graphical user interface, a textual, and/or auditory information, and which provides a view of the true energy demand and fully burdened costs of a supply chain. In addition, the user interface 130 allows the user and/or customer the ability to identify and focus efforts to reduce energy costs, increase effectiveness and/or security of supply, and allow trade-offs to be made between cost, carbon and emissions, security of supply and effectiveness to support holistic and/or system wide planning across the military force. It can be appreciated that in accordance with an exemplary embodiment, the system 100 can display 130 the fully burdened cost of energy (FBCE) for a given output by energy volumes used in a given timescale, carbon dioxide emissions produced in a given timescale, fully burdened cost of energy, security of energy supply and military effectiveness.

In accordance with an exemplary embodiment as shown in FIG. 1, the fully burdened cost of energy includes not only the cost of the fuel used by the end user, but the cost of equipment and personnel involved in the supply chain, the force protection required to protect the supply chain, and the infrastructure that supports all of these elements. In accordance with an exemplary embodiment, the security of energy supply can include failures of the energy supply chain, wherein a stock level falls below desired levels, and military effectiveness including the magnitude and duration of shortfalls in the energy supply. It can be appreciated that as required, the military effectiveness can also include interpretation and/or estimates of shortfalls in terms of capability lost (e.g., fewer hours of electricity generation or shorter patrol radius due to energy shortages).

In accordance with an exemplary embodiment, the supply chain 150 is reconfigured in accordance with the change in the at least one energy-related component within the supply chain. For example, a scenario of fuel supply in an operational theatre can be modelled, wherein an investigational run can include a model run for the scenario, which calculates the effort of energy resources required to deliver fuel to each location in the scenario, and therefore the fully burdened cost of energy. The user can then investigate the impact of changing the type of fuel tanker used in the scenario, and wherein the equipment in the model input data is changed to reflect this change in scenario. The model can then be run again, and the effort required of the energy resources now in the alternative scenario is calculated to provide a fully burdened cost of energy in the alternative scenario. The two runs can be compared to see the impact of changing the type of tanker on the effort required of other resources (e.g., change in storage equipment now needed) and on the fully burdened cost of energy at the locations in the scenarios. In accordance with an exemplary embodiment, the model output measures of cost, carbon, security of supply, and military effectiveness can then be used to assess the benefit/impact of the alteration made in the scenario.

It can be appreciated that although the exemplary embodiments are described in the terms of a military force, the systems and methods described herein can be extended to non-military uses as well. For example, the system and methods described herein can be applied to military, commercial operations including manufacturing, retail, mining, etc., governmental organization or agencies including health services and education, and/or charitable organizations.

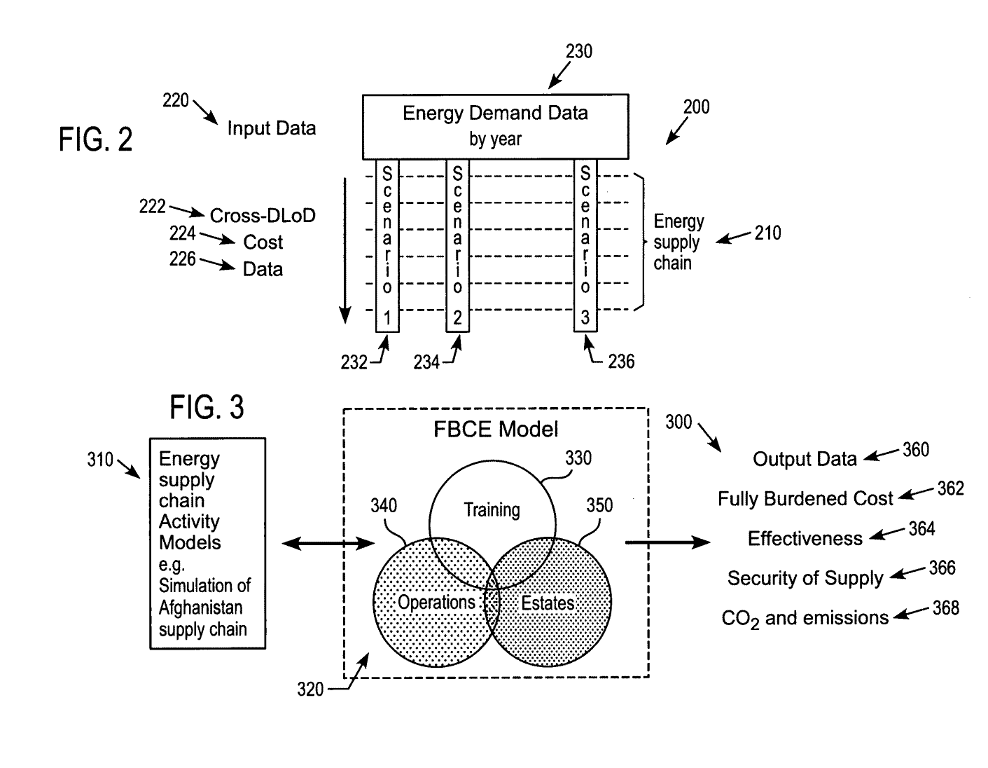

FIG. 2 illustrates a schematic of an exemplary embodiment of a system 200 for use in physically reconfiguring a supply chain 210. As shown in FIG. 2, the system 200 includes a plurality of input data 220 including information and/or data related to cross-defence lines of development (cross-DLoD) 222, costs 224 associated therewith, and other associated data 226 related thereto.

In accordance with an exemplary embodiment as shown in FIG. 2, the cross-defence lines of development data (cross-DLoD) 222 can include information and data related to training, equipment, personnel, information, concepts and doctrine, organization, infrastructure, logistics, and interoperability.

In accordance with an exemplary embodiment, the energy demand data 230 can be evaluated and/or calculated under different scenarios for the supply chain 210. For example, as shown in FIG. 2, the energy demand 230 can be evaluated and/or calculated under a plurality of scenarios, 232, 234, 236 (i.e. a first scenario 232, a second scenario 234, and a third scenario 236). Based on the results from the input data 220, a desired scenario can be selected, which meets certain requirements of the supply chain 210. It can be appreciated that in accordance with an exemplary embodiment, the different scenarios 232, 234, 236 can be created by changing at least one energy-related component (or physical parameter) within the supply chain 210. In accordance with an exemplary embodiment, changes in at least one energy-related component (or physical parameter) can be a change in technology options, and/or a change in behaviour, approach, or organization with the supply chain 210.

FIG. 3 illustrates a schematic of a system 300 for use in physically reconfiguring a supply chain 310 using a fully burdened cost of energy (FBCE) model 320. As shown in FIG. 3, the area of energy use (i.e. input) 320 within the supply chain 310 includes training 330, deployment and operations 340, and/or estates 350 (i.e. building and facilities). In addition, the supply chain 310 can include energy use associated with manufacturing, supply and/or distribution, end use, and re-manufacturing. For example, re-manufacturing can include renewable energy as well as modelling the fully burdened cost of water and/or waste water by recycling and/or re-manufacturing. In addition, end uses can include end use enabling equipment in the supply chain 310, which can include different ways of using energy to achieve the same capability, e.g. heating.

It can be appreciated that each of these areas of energy use 320 will have some overlap among one another. In accordance with an exemplary embodiment as shown in FIG. 3, the energy consumption (i.e. output) 360 can include fully burdened costs 362, military effectiveness 364, security of supply 366, and/or carbon and emissions 368. It can be appreciated that by changing at least one of the energy-related components (or physical parameters) within the supply chain 310, different scenarios can be evaluated for trade-offs between costs 362, military effectiveness 364, security of supply 366, and/or carbon and emissions 368.

In accordance with an exemplary embodiment, the system 300 can be configured to reduce current fossil fuel expenditures for a designated supply chain 310. For example, an emphasis on new technologies can be implemented to reduce fossil fuel usage by deploying an alternative source of energy, such as renewable power, HED, and/or thermal insulation. In addition, decisions can be made based on a fully burdened cost savings of new energy efficient technologies, which can be calculated and evaluated based on information related to more accurately defined pay-back periods, quantifying possible reductions in fossil fuel consumption, and understanding the impact on logistic convoys and force protection.

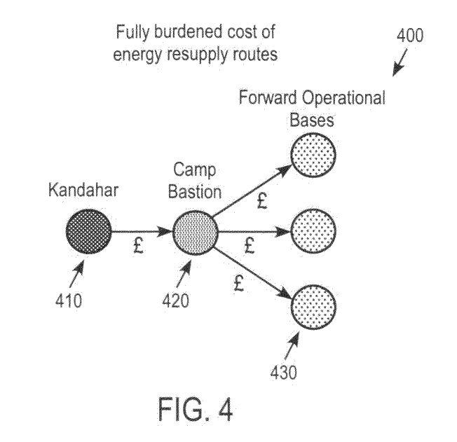

FIG. 4 illustrates a fully burdened cost of energy resupply routes 400, which is used to model a fully burdened cost of energy database model. As shown in FIG. 4, the supply chains has a home base and/or location 410, an intermediate base and/or location 420, and a plurality of forward operational bases and/or locations 430. For example, in FIG. 4, the home base 410 is identified as Kandahar, the intermediate base and/or location 420 is identified as Camp Bastion. Each of the bases and/or locations 410, 420, 430 has a plurality of energy-related components associated with training, operations and/or estate energy. The energy-related components can include actual energy sources (i.e. fossil fuels), cost of equipment and personnel involved in the supply chain, protection to deliver the actual energy source to a destination, and infrastructure to support the supply chain. It can be appreciated that although the supply chain 400 as shown in FIG. 4 is military related, the system and methods as described herein can be applied to commercial operations, such as the transportation of goods from a dock to one or more warehouses, and to retailers and/or distributors.

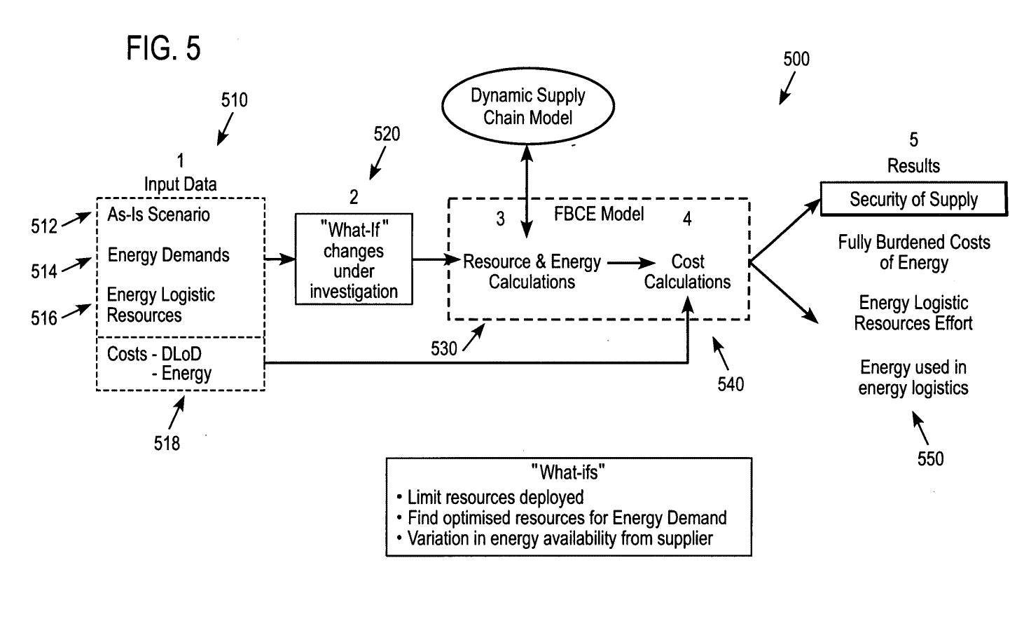

FIG. 5 illustrates a high level process diagram using a fully burdened cost of energy model and associated dynamic model in accordance with an exemplary embodiment. As shown in FIG. 5, the system 500 includes input data 510, which includes an “as is” scenario 512, energy demands 514, energy logistics and/or energy resources (i.e., energy-related components) 516, and associated costs 518. The costs 518 include costs associated with the “as-is” scenario and at least one or more alternative scenarios. In accordance with an exemplary embodiment, the costs 518 are costs associated with DLoD (Defence lines of development) activities and the energy-related costs. In accordance with an exemplary embodiment, an application of an alternative scenario (i.e. “What-If” changes) 520 under investigation or consideration is applied to the input data 510. For example, the alternative scenario (or “What-If” changes) 520 can be based on limited resource deployment, optimized resources for energy demand and/or a variation in available energy from a supplier.

In accordance with an exemplary embodiment as shown in FIG. 5, the system 500 calculates the effort 530 required from energy resources (or energy-related components) 516 in accordance with the at least one alternative scenario and the energy use of the energy resources (or energy-related components) 516 in the at least one alternative scenario using the database (or database plus dynamic models). The calculated cost 540 of these energy-related resources or components 516 are then shared along the supply chain (or supply route) according to effort. It can be appreciated that the supply chain can include not only energy use for training, deployment and operations, and/or estates (i.e. building and facilities), but also energy use associated with manufacturing, supply and/or distribution, end use, and re-manufacturing. The results 550 are then exported for analysis, including analysis of security of supply, fully burdened costs of energy (FBCE), energy logistics and/or resource efforts, and energy used in the energy logistics and/or resource efforts.

It can be appreciated that in accordance with an exemplary embodiment, the input data 510 can include scenario data, equipment data, energy volume data and costs. For example, the scenario data can include geographical data (location of nodes and resupply routes), laydown of energy resources, and time/effort spent by energy resources resupplying along routes. The equipment data can include capabilities of energy resources (e.g. storage/tanking volumes) and performance of energy resources and/or energy demand of equipment. The energy volume data can include energy use by financial year in estate, training and operational activity areas, energy demand of capability, resources at locations in the scenario, energy used by energy resources in energy supply, and volumes of energy delivered to locations in the scenario. In accordance with an exemplary embodiment, the amount of energy used can be measured and/or displayed in liters (or gallons or barrels) of fuel, kWhr (kilowatt hour) and/or Joules.

In addition, it can be appreciated that costs associated with an actual energy source, cost of equipment and personnel involved in the supply chain, protection to deliver the actual energy source to a destination, and infrastructure to support the supply chain are also included. The cost of equipment and personnel involved in the supply chain can include costs associated with food, water, waste, ammunition, spare parts and supplies, maintenance on equipment, engineering capabilities, education and/or transportation. In accordance with an exemplary embodiment, costs associated with waste and/or by-products, carbon emission credits, and/or liabilities (e.g. emission target penalties) can also be considered.

In accordance with an exemplary embodiment, the calculations 530, 540 can include laydown and effort required of energy resources, energy use, security of supply, and costing. The laydown and effort required of energy resources can include calculation of the effort required from equipment and infrastructure and the desired laydown in the energy supply chain to meet the energy demand, and calculation of the personnel associated with the equipment and infrastructure. The energy use calculation can also include the calculation of the energy used to supply energy to the point of energy demand. The security of supply includes calculation of instances of shortfall in the energy supply, in which the definition can be scenario specific. Costing can also include costing the equipment, infrastructure, personnel and energy used in energy logistics on each energy supply line in the scenario (i.e. fully burdened cost of all energy used in the scenario), and a comparison of the cost of energy supply lines and the volumes of energy which they deliver (i.e. a fully burdened cost of a unit of energy at points of energy demand in the scenario).

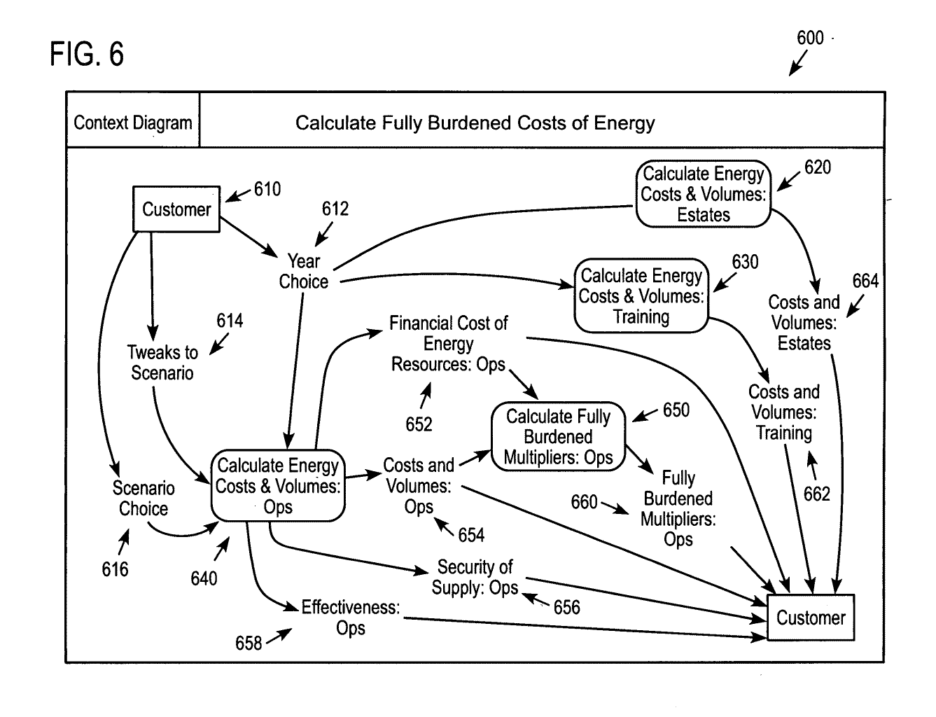

FIG. 6 illustrates a calculated fully burdened cost of energy system 600 in accordance with another exemplary embodiment. As shown in FIG. 6, the nodes represent calculations within the system 600, and the arrows represent the dependencies of these calculations on various data sets. In accordance with an exemplary embodiment, the operational (or “Ops”) sphere of activities is broken down in more detail as the first capability investigation (or modelling) is based on an operational (i.e. current scenario) and/or alternative scenario.

As shown in FIG. 6, the system 600 provides a model or means for calculating the fully burden costs of energy use in a military and/or commercial operation, across all branches of service and/or divisions, respectively, for a customer 610. It can be appreciated that in accordance with an exemplary embodiment as shown in FIG. 6, the energy use areas can include: (1) training (i.e. non-operational uses); (2) deployments; and (3) estates energy (i.e., the running and/or operations of buildings and facilities). It can be appreciated that in accordance with an exemplary embodiment, the system 600 can provide a wide-ranging picture of how and why energy is used, which allows the customer 610 (or provider) the ability to calculate the “fully-burdened” cost of energy. It can be appreciated that the “fully burdened” cost of energy is not just the cost of the fuel used at the front line (or end location), but the cost of equipment and personnel involved in the supply chain, the military force required to protect the supply chain, and the infrastructure that supports all of these elements.

As shown in FIG. 6, the customer 610 (or provider) can select a year 612, and provide changes (or tweaks) to a scenario 614 and/or a scenario choice 616. The customer's input to year 612, scenario 614 and/or scenario choice 616 provides the system 600 with the basic data and/or information necessary to calculate energy costs and volumes for estates 620, energy costs and volumes for training 630, energy costs and volumes for operations 640, and fully burdened multipliers for operations 650 for the customer (or provider) 610. Other factors can include financial cost of energy resources (operations) 652, cost and volume (operations) 654, security of supply (operations) 656, effectiveness (operations) 658, fully burdened multipliers (operations) 660, costs and volumes (training) 662, costs and volumes (estates) 664.

It can be appreciated that in accordance with an exemplary embodiment, the system 600 as shown in FIG. 6 can be used to calculate the fully burdened impact of alternative ways of generating, supplying and using energy to a supply chain and/or across a plurality of military branches (e.g. the British Ministry of Defence (MoD)). It can be appreciated that these changes (i.e. tweaks) to the scenario 614 and/or scenario choice 616 can be technology based or in behaviour, approach and/or organizational. In addition, the system 600 is configured not only to calculate costs, but four output measures which are the drivers around energy use in the MoD including (1) cost; (2) carbon and emissions; (3) security of supply (assessed by military judgment or specific measures relevant to a scenario such as volume of fuel needed to stockpile or the level of redundancy); and (4) military effectiveness (assessed by military judgment or specific measures relevant to a scenario). In accordance with an exemplary embodiment, the system 600 allows users (i.e. customers) 610 the ability to compare the alternatives to the current scenario and make trade-offs between these four output measures.

In accordance with an exemplary embodiment, the initial data is gathered, which gives a top-level baseline understanding of energy in the supply chain and/or throughout a military force or division (i.e. MoD). The top-level baseline data provides a start to the modelling. However, it can be appreciated that additional data gathering is an ongoing process and can be re-visited for the requirements of each investigation using the system to meet the requirements of each individual customer.

In accordance with an exemplary embodiment as shown in FIG. 6, each system 600 is made up of a fully burdened cost of energy database model and a dynamic supply chain model, which is specific to the scenario under investigation. It can be appreciated that the dynamic supply chain model sits within the database model. In accordance with an exemplary embodiment, the fully burdened cost of energy model provides a top level view of energy expenditure throughout a military division (e.g. United Kingdom military) and/or commercial operation. In addition, the fully burdened cost of energy model provides estimates on the effect of actions and/or different scenarios that will alter and/or affect the energy expenditures.

It can be appreciated that there are a large number of factors that affect energy expenditure making it impractical to model them all. In accordance with an exemplary embodiment, the model will focus on the most significant energy uses in a military division (e.g. United Kingdom military). However, it can be appreciated that in accordance with an exemplary embodiment, the system and model will retain the flexibility to be expanded if a more detailed study is required to examine specific areas of energy use.

In accordance with an exemplary embodiment as shown in FIG. 6, the fully burdened cost of energy database model (or system) can include: (1) baseline data of fuel use across financial years; (2) data from the training, estate and operation spheres of energy use, enabling comparison between them; (3) detailed scenario-specific data such as equipment numbers, vehicle performance data, costs of the equipment etc.; (4) perform straightforward manipulation of data e.g. calculating energy demand of equipments in the scenario; (5) contain all cost-calculations which give the fully burdened cost of energy; and (6) calculate fully burdened cost of energy ‘multipliers’, which represent the cost of the supply chain delivering fuel to that of the fuel itself, which can be expressed as a multiplication factor which can be applied to a unit of fuel to express its fully burdened cost at its point of use.

It can be appreciated that in accordance with another exemplary embodiment, the system and method provides the ability to drill down into the node ‘Calculate energy Costs & Volume, and show the ‘What-Ifs’ as ‘tweaks’ (or changes) to the scenario being investigated. For example, the evaluation of the impacts of the tweak (or change) in the node ‘Calculate Energy Expended: Ops’ (which contains the dynamic supply chain model (FIG. 5) for Operations discussed in more detail below) can be calculated and evaluated for a resultant energy and resource (infrastructure, equipment, etc.) demand; and the revised resources informing the cost calculation for the ‘tweaked’ (or changed) scenario.

It can be appreciated that in accordance with an exemplary embodiment, the purpose of the dynamic supply chain model is to provide the capability to investigate alternative scenarios (i.e. “What If questions”) in capability investigations to a higher accuracy than can be achieved by the database model alone. In accordance with an exemplary embodiment, both the database and dynamic supply chain models can identify opportunities for reductions in the supply chain and fuel used in logistics, and their impacts. In addition, the model can represent the removal of infrastructure and equipment from the supply chain due to reduced demand, and allow a quantification of the fuel used in energy logistics.

In accordance with an exemplary embodiment, the outputs of the model will feed into the fully burdened cost of energy database model to allow calculation of the cost implications of the alternative scenarios (i.e. the “What If questions”). It can be appreciated that in accordance with an exemplary embodiment, specific dynamic supply chain model(s) may be required for each investigation, and may sit within one or more of the activity areas including training, operations, and/or estates.

In accordance with an exemplary embodiment, the dynamic operations supply chain model system can: (1) simulate the energy supply chain in the scenario under investigation; (2) run the simulation in a suitable time-scale e.g. energy moved by day for a year; (3) calculate the energy used in energy logistics over this time period; (4) model changes in the supply chain required for pre-defined changes in the scenario, so that the fully burdened impact can be assessed; (5) output the altered resource demand (in terms of equipment, personnel and infrastructure); (6) measure security of supply e.g. instances of stockpiles falling below an acceptable level; and (7) measure effectiveness of the supply chain e.g. instances of the energy supply not meeting demand.

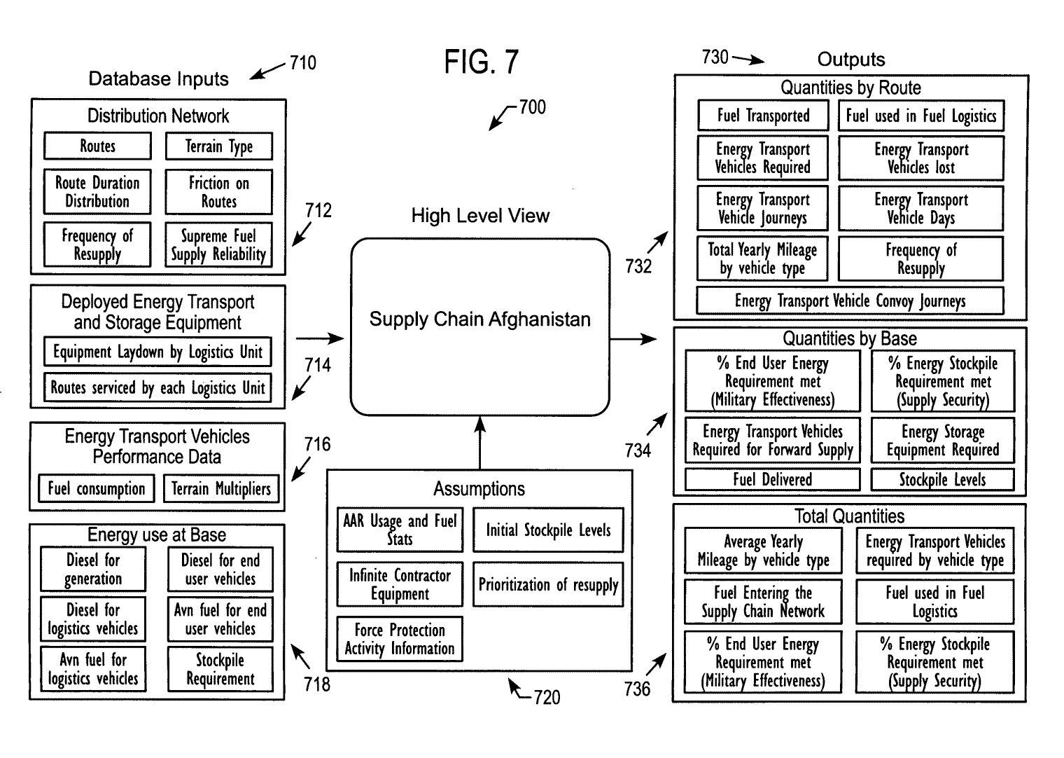

As an example, the input and outputs from a dynamic supply chain model 700 for an energy supply chain in a foreign country (i.e. Afghanistan) are shown in FIG. 7. As shown in FIG. 7, the results from the combined models can provide for each scenario (or alternative scenario): (1) fully burdened cost of energy; (2) multipliers representing the fully burdened cost of energy per unit of fuel at its point of use; (3) amount of energy used; (4) CO₂ (Carbon dioxide) and emissions; (5) energy used in energy logistics; (6) equipments, infrastructure and personnel required in energy logistics; (7) security of supply e.g. stockpile volumes; and (8) effectiveness e.g. failure to supply the fuel demand of the forces. It can be appreciated that the associated impacts of energy shortfalls will be assessed by subject matter experts outside of the modelling process. It can also be appreciated that the impact of each scenario as a whole as well as at various locations and on various lines of communication in the energy supply chain can be used to identify key problem areas where more effort and cost are involved in supplying energy.

As shown in FIG. 7, the inputs 710 can include distribution networks 712, deployed energy transportation and storage equipment 714, energy transportation vehicles performance data 716, and energy use at base 718. In addition certain assumptions 720 can be made, which are needed to perform the basis calculations. It can be appreciated that if any of assumptions change, the scenarios will need to be recalculated. The basis assumptions can include AAR (air-to-air refueling) usage and fuel stats, infinite contractor equipment, force protection activity information, initial stockpile levels and prioritization of resupply. The outputs 730 can include quantities per route 732, quantities per base 734 and total quantities 736.

In accordance with another exemplary embodiment, the capability investigations model will support capability investigations based on a current scenario and/or alternative scenarios. For example, the model can evaluate and/or calculate (1) fully burdened cost savings of new technologies in order to support investment decisions; (2) fossil fuel demand reduction to reduce the logistic chain and ‘tether of fuel’ in operations or improve security of supply; (3) understand the possible impacts of fuel shortages; and (4) investigate methods of reducing the carbon emissions of individual activities or across all of defence.

In addition, alternative (‘What-Ifs’) scenarios can be assessed by comparing the baseline results with those obtained after affecting changes in the modelled scenario. For example, a first capability investigation can investigate the fully burdened cost savings and other benefits of using new technologies to reduce fossil fuel consumption, which can include: (1) demand reduction technologies at bases e.g. improved thermal insulation; (2) improved fuel efficiency of vehicles e.g. hybrid drives; and/or (3) alternative energy production e.g. solar or wind. It can be appreciated that some non-technological quick-wins e.g. organization of supply chain or policy will also be investigated as appropriate. The dynamic supply chain model as shown in FIG. 7 represents the fuel supply chain in Afghanistan. The supply chain includes both ground and air lines of communication and the logistics effort supplied by both the military and contractors; in theatre and supported from the home country (i.e. United Kingdom).

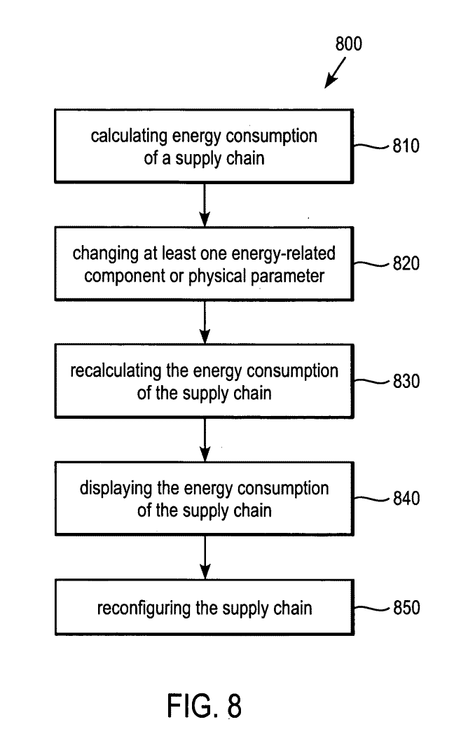

FIG. 8 is a flow chart that illustrates a series of steps 800 for monitoring energy consumption in accordance with an exemplary embodiment. In step 810, energy consumption of a supply chain in calculated. In step 820, at least one energy-related component or physical parameter within the supply chain is changed. In step 830, the energy consumption of the supply chain is recalculated. In step 840, the energy consumption of the supply chain is displayed as a result of the changing the at least one energy-related component or physical parameter within the supply chain. In step 850, the supply chain is reconfigured in accordance with the change in the at least one energy-related component or physical parameter within the supply chain.

In an exemplary embodiment, a computer program which implements all or parts of the processing described herein through the use of a system and/or methodology as illustrated in FIGS. 1-8 can take the form of a computer program product residing on a computer usable or computer readable medium. Such a computer program can be an entire application to perform all of the tasks necessary to carry out the processes and/or methodologies, or it can be a macro or plug-in which works with an existing general-purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

### EXAMPLE

In this specific example, an energy consumption calculation for a given scenario is provided together with discussion of an energy consumption alternative that can be presented to the user (to reduce consumption).

### Current Scenario

The energy supply chain (for diesel) of the scenario comprises three location A, B and C at which there are specified end user demands for diesel:

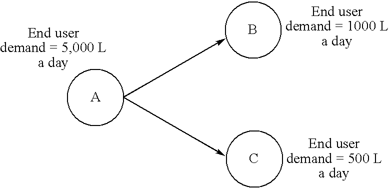

### Scenario Information

### Resupply Routes

Convoys every 10 days
Convoys take 2 days (round trip) for A-B-A and A-C-A

### Storage Solutions:

All locations need storage capacity for 10 days usage
X—6,000 L capacity
1 person
Costs £5,000 a year
Y—25,000 L capacity
2 people
Costs £15,000 a year

### Tankers on Route A-B and A-C

Tanking vehicle holds 2,000 L
1 person
Costs £200,000 a year
Burns fuel at 20 km/L
For Route A-B-A each tanker vehicle burns 100 L
For route A-C-A each tanker vehicle burns 100 L

### Personnel

Each person in the supply chain costs £100,000 a year

### Energy Use in the Scenario:

$$\begin{matrix}Daily end user demands = ( ( A ) 5 , 000 + ( B ) 1 , 000 + ( C ) 500 ) \\ = 6 , 500 L a day \\ = {365}^{*} , 6500 \\ = 2 , 372 , 500 L a year\end{matrix}$$

### Convoy Fuel Burn:

Route A-B-A needs 5 tankers (2,000 L each) to tank 10 days of supply (10,000 L)
5 tankers*100 L fuel burn=500 L every 10 days
There are 365/10=36 convoys a year, so use 18,000 L a year
Route A-C-A needs 3 tankers (2,000 L each) to tank 10 days of supply (5,000 L)
3 tankers*100 L fuel burn=300 L every 10 days
There are 365/10=36 convoys a year, so use 10,800 L a year
So total fuel use in scenario in a year=2,372,500+10,800+18,000=2,401,300 L a year

### Equipment Costs Use in the Scenario:

### Laydown of Storage Equipment:

Need storage capacity of 10 days use at all locations.
A—3*storage solution Y=3*£15,000=£45,000 a year
B—2*storage solution X=2*£5,000=£10,000 a year
C—1*storage solution X=1*£5,000=£5,000 a year

### Laydown of Tankers:

Need 5 for ABA and 3 for ACA but as each only takes 2 days and the convoys are sent every 10 days this demand can be met by a fleet of 5 vehicles.
5*£200,000=£100,000 a year
Total equipment cost=£100,000+£45,000+£10,000+£5000=£160,000 a year

### Personnel Cost in the Scenario:

### Storage Personnel:

A=3 equipments*2 people=6 people
B=2 equipments*1 person=2 people
C=1 equipments*2 person=1 person
Tankers=5 equipments*2 people=10 people
Total personnel=19
Cost of 1 person=£100,000 a year
Personnel cost=£1,900,000 a year
Energy Equipment & Personnel Cost in the Scenario=£2,060,000 a year

### Alternative Scenario

Change the end user demand for diesel at location B to be 50% of that in the ‘current’ scenario.

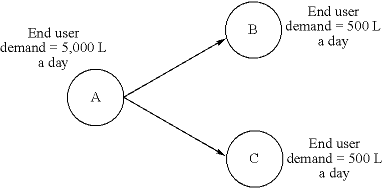

Use the same Scenario Information as in the ‘current’ scenario.

### Energy Use in the Alternative Scenario:

$$\begin{matrix}Daily end user demands = ( ( A ) 5 , 000 + ( B ) 500 + ( C ) 500 ) \\ = 6 , 500 L a day \\ = {365}^{*} , 6000 \\ = 2 , 190 , 000 L a year\end{matrix}$$

### Convoy Fuel Burn:

Route A-B-A now only needs 3 tankers (2,000 L each) to tank 10 days of supply (5000 L)
3 tankers*100 L fuel burn=300 L every 10 days
There are 365/10=36 convoys a year, so use 10,800 L a year
Route A-C-A needs 3 tankers (2,000 L each) to tank 10 days of supply (5,000 L)
3 tankers*100 L fuel burn=300 L every 10 days
There are 365/10=36 convoys a year, so use 10,800 L a year
So total fuel use in scenario in a year=2,190,000+10,800+10,800=2,211,600 L a year

### Equipment Costs Use in the Alternative Scenario:

### Laydown of Storage Equipment:

Need storage capacity of 10 days use at all locations.
A—3*storage solution Y=3*£15,000=£45,000 a year
B—1*storage solution X=1*£5,000=£5,000 a year
C—1*storage solution X=1*£5,000=£5,000 a year

### Laydown of Tankers:

Need 3 for ABA and 3 for ACA but as each only takes 2 days and the convoys are sent every 10 days this demand can be met by a fleet of 3 vehicles.
3*£200,000=£60,000 a year
Total equipment cost=£60,000+£45,000+£5,000+£5000=£115,000 a year

### Personnel Cost in the Alternative Scenario:

### Storage Personnel:

A=3 equipments*2 people=6 people
B=1 equipment*1 person=1 people
C=1 equipments*2 person=1 person
Tankers=3 equipments*2 people=6 people
Total personnel=14
Cost of 1 person=£100,000 a year
Personnel cost=£1,400,000 a year
Energy Equipment & Personnel Cost in the Scenario=£1,515,000 a year

### Comparison of Current and Alternative Scenario

Energy Equipment & Personnel Cost Saving in the alternative scenario=(£2,060,000−£1,515,000)=£545,000 a year
Reduction in energy use in the alternative scenario=(2,401,300−2,211,600)=189,700 L a year

It is to be understood that any feature described in relation to any one embodiment or Example may be used alone, or in combination with other features described, and may also be used in combination with one or more features of any other of the embodiments or Examples, or any combination of any other of the embodiments and Examples. Further, equivalents and modifications not described above may also be employed without departing from the scope of the invention, which is defined in the accompanying claims.

1. A system for use in physically reconfiguring a supply chain, comprising:
a memory for storing energy-related components within a supply chain;
a processor for evaluation of energy consumption within the supply chain in accordance with a current scenario and at least one alternative scenario in which at least one energy-related component or physical parameter within the supply chain is changed; and
a user interface for displaying the energy consumption of the current scenario and the at least one alternative scenario.

2. The system of claim 1, wherein the change in the at least one energy-related component or physical parameter within the supply chain is a change in technology options, a change in behaviour, approach, or organization within the supply chain, and/or a change in energy demand.

3. The system of claim 1, wherein the energy-related components within the supply chain are generated from energy use in training, deployment and/or estate energy.

4. The system of claim 3, wherein the energy use further includes transport, logistics and/or other assets.

5. The system of claim 1, wherein the user interface displays energy consumption in the form of cost, carbon and emissions, security of supply, and/or effectiveness.

6. The system of claim 5, wherein the at least one alternative scenario provides a trade-off between the cost, carbon and emissions, security of supply, and/or effectiveness.

7. The system of claim 5, wherein the cost includes a cost element associated with an actual energy source, cost of equipment and personnel involved in the supply chain, protection to deliver the actual energy source to a destination, and infrastructure to support the supply chain.

8. The system of claim 7, wherein the costs further includes costs associated with waste and/or by-products, carbon emission credits, and/or liabilities.

9. The system of claim 1, wherein the supply chain is a commercial operation.

10. The system of claim 1, wherein the supply chain is a governmental operation.

11. The system of claim 1, wherein the supply chain is a charitable operation.

12. A system for use in physical reconfiguring energy consumption of a supply chain, comprising:
a memory for storing physical parameters for energy consumption of a supply chain;
a processor for evaluation of energy consumption of the supply chain, and wherein upon a change in at least one of the physical parameters of the supply chain, the processor calculates a new energy consumption of the supply chain; and
a user interface for displaying an original energy consumption and the new energy consumption of the supply chain.

13. The system of claim 12, wherein the change in the at least one of the physical parameters within the supply chain is a change in technology options, a change in behaviour, approach, or organization within the supply chain, and/or a change in energy demand.

14. The system of claim 12, wherein the physical parameters of the supply chain under investigation are generated from energy use related to training, deployment and/or estate energy.

15. The system of claim 14, wherein the energy use further includes transport, logistics and/or other assets.

16. A system for use in physically reconfiguring a supply chain, comprising:
a memory for storing energy-related components within a supply chain;
a processor for evaluation of energy consumption within the supply chain in accordance with a first state and at least one second state in which at least one energy-related component or physical parameter within the supply chain is changed; and
a user interface for displaying the energy consumption of the first state and the at least one second state.

17. The system of claim 16, wherein the change in the at least one energy-related component or physical parameter within the supply chain is a change in technology options, a change in behaviour, approach, or organization within the supply chain, and/or a change in energy demand.

18. A method of monitoring energy consumption, comprising:
calculating energy consumption of a supply chain;
recalculating the energy consumption of the supply chain by changing at least one energy-related component or physical parameter within the supply chain;
displaying the energy consumption of the supply chain as a result of changing the at least one energy-related component or physical parameter within the supply chain; and
reconfiguring the supply chain in accordance with the change in the at least one energy-related component or physical parameter within the supply chain.

19. The method of claim 18, wherein the step of calculating energy consumption of a supply chain further includes evaluating, managing and predicting energy consumption of the supply chain.

20. The method of claim 18, wherein the changing the at least one energy-related component or physical parameter within the supply chain is a change in technology options, a change in behaviour, approach, or organization within the supply chain, and/or a change in energy demand.

21. The method of claim 18, wherein the energy-related components within the supply chain are generated from energy use in training, deployment and/or estate energy.

22. The method of claim 21, wherein the energy use further includes transport, logistics and/or other assets.

23. The method of claim 18, wherein a user interface displays energy consumption in the form of cost, carbon and emissions, security of supply, and/or effectiveness.

24. The method of claim 23, wherein the changing the at least one energy-related component or physical parameter within the supply chain provides a trade-off between the cost, carbon and emissions, security of supply, and/or effectiveness.

25. The method of claim 24, wherein the cost includes a cost element associated with an actual energy source, cost of equipment and personnel involved in the supply chain, protection to deliver the actual energy source to a destination, and infrastructure to support the supply chain.

26. The method of claim 25, wherein the costs further includes costs associated with waste and/or by-products, carbon emission credits, and/or liabilities.

27. A computer readable medium containing a computer program for displaying energy consumption of a supply chain, wherein the computer program comprises executable instructions for:
calculating energy consumption of a supply chain;
recalculating the energy consumption of the supply chain by changing at least one energy-related component or physical parameter within the supply chain;
displaying the energy consumption of the supply chain as a result of the changing the at least one energy-related component or physical parameter within the supply chain; and
reconfiguring the supply chain in accordance with the changing the at least one energy-related component or physical parameter within the supply chain.

28. The computer readable medium of claim 27, wherein the changing the at least one energy-related component or physical parameter within the supply chain is a change in technology options, a change in behaviour, approach, or organization within the supply chain, and/or a change in energy demand.

29. (canceled)

30. (canceled)

31. (canceled)
